(19) United States
(12) Patent Application Publication
(10) Pub. No.: US 2017/0159621 A1
(43) Pub. Date: Jun. 8, 2017

(54) ADVANCED INTERNAL COMBUSTION ENGINE AIR INDUCTION CLEANING SYSTEM AND METHOD

(71) Applicant: Robert Scott Irwin, Peru, IL (US)

(72) Inventor: ROBERT SCOTT IRWIN, PERU, IL (US)

(21) Appl. No.: 15/043,805

(22) Filed: Feb. 15, 2016

Related U.S. Application Data
(63) Continuation-in-part of application No. 14/964,794, filed on Dec. 10, 2015, now abandoned.
(60) Provisional application No. 62/122,328, filed on Oct. 10, 2014.

(51) Int. Cl. F02M 35/08

(52) U.S. Cl. CPC F02M 35/08

(57) ABSTRACT

An advanced engine air induction cleaning system and method allows for the safe spraying of multiple types cleaning solutions in alternating, pulsed sequences into the air intake system of a gasoline engine to create a frequency of thermal shocks to the air intake system. The system and method disclosed creates a feedback loop to the system that detects when the vehicle begins to stall, so that the system can stop the spraying of cleaning solutions into the engine's air intake to avoid pooling of the cleaning solutions in the engine and thereby avoiding hydro lock conditions. The system and method also creates an excess bottle to hold the excess cleaner to allow the engine to ingest only the requisite amount of cleaner to aid in preventing pooling of cleaner to avoid hydro lock conditions.

### CROSS REFERENCE TO RELATED APPLICATIONS

This application is a continuation in part of U.S. pat. app. Ser. No. 14/964,794, filed Dec. 10, 2015, which claims the benefit of U.S. Provisional Application Ser. No. 62/122,328, filed Oct. 10, 2014, each of which are incorporated by reference herein in their entirety.

### BACKGROUND OF THE INVENTION

In a representative internal combustion engine of an automobile, an intake manifold conveys intake air to intake valves of engine combustion cylinders. The intake valves are normally closed, but open at certain times during the operating cycle of each cylinder. Pistons that reciprocate within the engine cylinders are coupled by connecting rods to a crankshaft. When the normally closed intake valves open, fuel, such as gasoline, is sprayed by electric-operated fuel injectors into intake air entering the cylinders, creating charges of combustion gases that pass through the open intake valves and into the combustion cylinders. After the intake valves close, the charges are compressed by the pistons during compression strokes. Then, for gasoline engines, gasoline is ignited by electric sparks at the beginning of power strokes to thereby drive the pistons and power the engine.

The air intake system for an engine comprises a succession of components that run in series, beginning at a dirty air inlet, and ending at the engine. Dirty air is conveyed through a dirty air duct to an air box. A particulate filter within the air box filters certain particulate material from the intake air flow, so that clean air emerges from the air box. That clean air passes through a throttle that operates to selectively restrict the flow. From there the flow passes to a plenum, and thence through individual tracts, or runners, leading to the individual engine cylinders.

Heavy deposits are common in the air intake because to help control emissions, noxious exhaust gases and crankcase vapors are captured and fed back into the air intake system. Gummy substances contained in these vapors combine with dirt and form deposits. These deposits will substantially reduce airflow, disrupting the critical air/fuel ratio that is essential to engine operation and fuel efficiency. Operational problems such as rough idle, poor performance, and increased exhaust emissions result from heavy deposit buildup. The heavy deposits may be hard or soft deposits.

To avoid the heavy deposit buildup in the air intake system, cleaning is required. An induction engine cleaning or air intake induction cleaning may include a fuel additive detergent and an air intake cleaning done by a cleaning solution. As is known in the art, the combustion chamber and air intake is sprayed with a cleaning solution by a pressurized system while the automobile is running at approximately 2000 rpm and a fuel additive detergent may also be added to the gasoline tank. A nozzle to distribute the cleaner is inserted into through one of: an air intake hose in front of a throttle body, a vacuum hose port, or a sensor port. In some cases, it is required to remove the throttle body to clean or to attach the nozzle.

As the engine is running through the cleaning process, the first spray of a pressurized cleaner creates a thermal shock when the cool pressurized cleaning solution engages the hot engine. Thermal shocking also occurs to the heavy deposits situated in the air intake. The thermal shocking of the deposits creates mechanical fractures in the deposits that allow the cleaning solution to penetrate better and clean better. Thermal shocking only occurs at the initial start of the cleaning process; and as the temperatures gravitate toward a norm, the effectiveness of the thermal shock cleaning process diminishes.

A disadvantage to running an engine while going through the induction cleaning process is the potential to create a hydro lock. Hydro lock occurs when the cleaning solution pools up in the intake manifold and chokes the air intake system thereby causing the engine to stall and stop. If the cleaning solution has pooled in the intake manifold, the liquid can flow into a cylinder or cylinders and create a non-compressible surface on top of the piston. If the engine is then started the resulting added dimension created can cause interference with the head assembly and cause piston, piston rod or other damage to the engine.

A need therefore exists for a method and system that allows for the safe spraying of cleaning solution into the hot air intake system of a gasoline engine that will maintain the efficiency of the initial thermal shock to remove hard and soft deposits and without creating a pool of the cleaning solution that stalls the engine.

### BRIEF SUMMARY OF THE INVENTION

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

In one embodiment of the present invention, an engine air intake cleaning system comprises an enclosure for housing a cleaning agent; a nozzle; a conduit allowing movement of the cleaning agent from the enclosure to the nozzle; a valve having first and second positions, the valve first position being an open position allowing the cleaning agent to pass therethrough, the valve second position being a closed position restricting the cleaning agent from passing therethrough; a controller in communication with the valve to control the position of the valve; and a sensor detecting engine idle information and communicating at least some of the detected engine idle information to the controller; wherein the controller positions the valve at the second position when the controller determines from the communicated engine idle information that engine idle has reached a threshold minimum performance. It is foreseen that the sensor may be one of: a vacuum sensor, an air pressure sensor, a power sensor, a temperature sensor, and a vibration sensor. It is foreseen that more than one enclosure for housing a cleaning agent and valve may be utilized in the present invention. It is foreseen that the nozzle may further include a nozzle adapter configured to allow for connection of the nozzle to at least one of the following engine outlets: an air intake hose, a vacuum hose port, or a sensor port.

The system avoids hydro-lock and potential engine damage by creating a feedback to the system delivering the cleaner to the engine to determine when the vehicle begins to stall or if the vehicle does stall, and then the system stops the spraying of cleaner into the engine's air intake. If the controller receives idle information that the engine is preparing to stall or a threshold minimum performance, the controller positions the valve or valves into a closed position for a predetermined amount of time to allow the engine to get back up to above the threshold and not about to stall. If the controller receives idle information that the engine has stalled or reached a zero performance, the controller positions the valve or valves into a closed position, thereby preventing the engine from creating a hydro lock condition.

In another embodiment, the cleaning agent is a first cleaning agent, and a second cleaning agent is situated within a second enclosure. The engine air intake cleaning system further comprises a second valve controlled by the controller, and wherein the controller alternates the position of the first valve to be opposite the position of the second valve, thereby alternating the flow of the first and second cleaning agents.

It is foreseen that the controller may alternate the speed of changing the first valve from the first position to the second position a predetermined multiple faster than the second valve.

In another embodiment of the present invention, an engine air intake cleaning system comprises: an enclosure for housing a cleaning agent; a nozzle; an excess cleaner collection container, the nozzle being situated within the collection container; and a first hose or conduit allowing movement of the cleaning agent from the enclosure to the nozzle; a second hose or conduit allowing fluid movement of the cleaning agent from the collection container to an opening in a vehicle engine, whereby the cleaning agent in the collection container is accessible to the engine.

In another embodiment of the present invention, an engine air intake cleaning system, comprises: an enclosure for housing a cleaning agent; a nozzle; a nozzle adapter configured to connect the nozzle to an engine outlet; a hose or conduit allowing movement of the cleaning agent from the enclosure to the nozzle; a valve having open and closed positions; a controller to control the position of the valve; and wherein the controller alternates the position of the valve, thereby altering the flow of the at least one cleaning agent.

In a method of cleaning the air induction of a vehicle engine according to the present invention, comprising the steps of: inputting a cleaning solution into a canister and pressurizing the canister; installing at least one cleaning solution hose from the canister to a nozzle, such that the cleaning solution has a pathway from the canister to the nozzle; installing a sensor on the vehicle engine; idling the vehicle engine a predetermined revolutions per minute (rpm), usually between 2000 and 2500 rpm; providing idle information from the sensor to a controller; spraying the cleaning solution into the vehicle engine via the nozzle; stopping the spray of the cleaning solution when the idle information received by the controller indicates at least one of: the vehicle engine is about to stall and the vehicle engine has stalled.

It is foreseen that the method may further comprise the steps of: inputting a second cleaning solution into a second canister and pressurizing the second canister; wherein: the cleaning agent flows to a first valve and the second cleaning agent flows to a second valve; the valves flow to the nozzle; the first and second valves each have an open position for allowing passage of the respective cleaning agent therethrough and a closed position restricting passage of the respective cleaning agent therethrough; the controller controls the position of the first and second valves; and the controller positions the first and second valves to the open position in an alternating manner.

In another embodiment of the method further comprising the step of: adding a fuel additive into the gasoline tank via the filler neck; inputting the make, model, engine, and make year, to an application, the application will advise in selecting an engine adapter.

It is foreseen that the method further comprises installing an engine adapter on one of: an air intake hose in front of a throttle body, a vacuum hose port, or a sensor port.

It is further foreseen that the method will further comprise the step of blowing air through the nozzle into the air intake system once the cleaning solution canisters have each been emptied or the cleaning has been completed.

The drawings constitute a part of this specification and include exemplary embodiments of the present invention and illustrate various objects and features thereof.

### BRIEF DESCRIPTION OF THE DRAWINGS

FIG. 1 is a top perspective view of a gasoline engine air induction cleaning system according to one embodiment of the present invention.

FIG. 1A is a side view of a front panel of the gasoline engine air induction cleaning system according to one embodiment of the present invention.

FIG. 2 is a schematic view of a canister assembly according to one embodiment of the present invention.

FIG. 3 is a schematic configuration view of a sensor control subassembly according to one embodiment of the present invention,

FIG. 4 is a flow diagram chart of a gasoline engine air induction cleaning method according to one embodiment of the present invention.

FIG. 5 is top perspective view of an external excess cleaner bottle assembly according to one embodiment of the present invention.

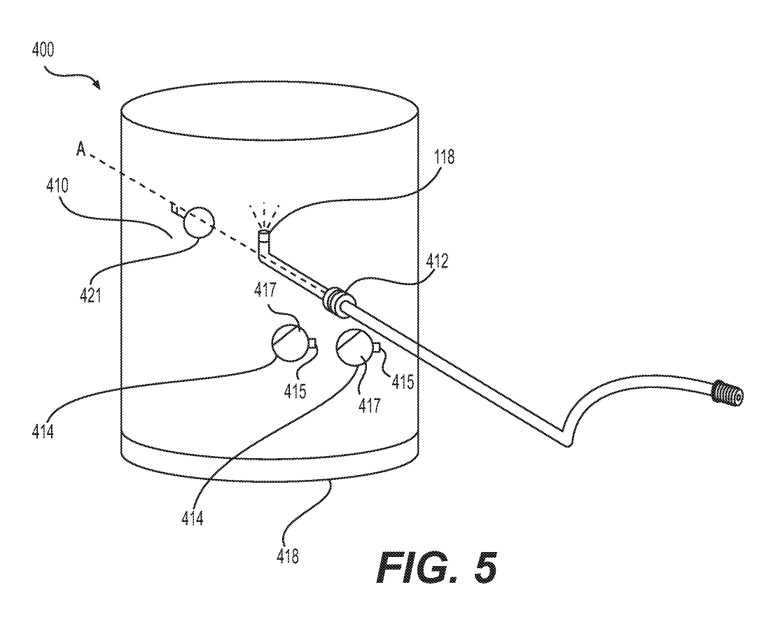

### DETAILED DESCRIPTION

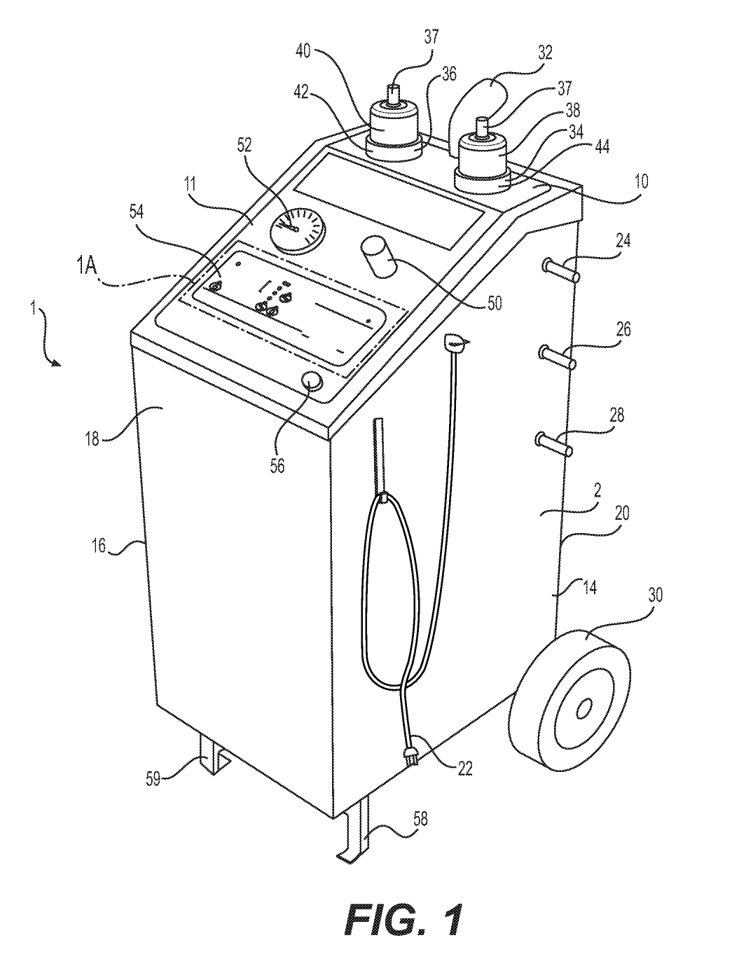

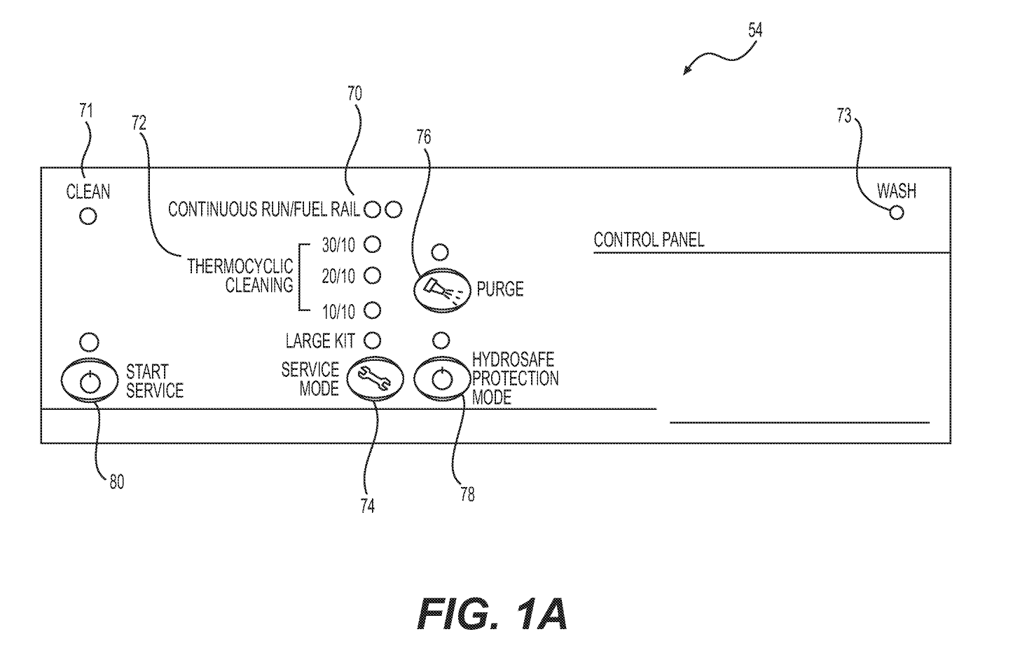

Engine air intake cleaning systems and methods of cleaning the air induction of a vehicle engine are illustrated in FIGS. 1-4. Referring to FIG. 1, the reference numeral 1 generally designates an advanced gasoline engine air induction cleaning system according to the present invention. The advanced gasoline engine air induction cleaning system 1 includes a housing 2. The housing 2 is rectangular in shape with a top surface 10, a face plate 11, a bottom surface 12, side surfaces 14, 16, a front surface 18, and a back surface 20. The side surface 14 is illustrated to include a power cord 22, a first cleaning solution port 24, a second cleaning solution port 26, and an air port 28. The power cord 22 may be adapted to be plugged into one of: internal 12V power source, wall outlet, jump pack, or car battery. The first cleaning solution port 24 and the second cleaning solution port 26 may be quick connect and disconnect hose ports that allow versatility of being changed from induction cleaning to fuel rail cleaning to diesel cleaning or turbo diesel cleaning. It is foreseen that the ports 24, 26, 28 may also be on side surface 16 or some combination thereof. Each side surface 14, 16 may further include a wheel 30. It is foreseen that the wheels may also engage the bottom surface 12. The housing 2 of the invention is typically made from a metal, metal alloy, or other suitable materials, including (for example) plastic polymers and composites containing carbon fiber.

The top surface 10 of the cleaning system 1 includes a handle 32 and first and second cylindrical insets 34, 36. Each cylindrical inset 34, 36 are sized and shaped to receive a canister lid 38, 40. It is envisioned that the lids 38, 40 are screwed on, but they may be otherwise attachable to the cylindrical insets 34, 36. The illustrated canisters 42, 44 further include a metal fitting 37 for aerosol delivery of cleaning solution 39, 41. It is foreseen that a cleaning solution 39 may be poured into the canister insets 34, 36, and then sealed, so canisters 42, 44 may then be pressurized. The canisters 42, 44 of the invention are typically made from a metal, such as aluminum, metal alloys, or other suitable materials, including plastic polymers and composites shown) and canisters (not shown) may be installed and utilized. It is also foreseen the handle may situated to engage the back surface 20 and run along the top surface 10, so as to enable two handed use. It is foreseen that the canisters 42, 44 will further include a hole (not shown) located above a full fill line of the container to allow for attachment of a hose fitting (not shown) to allow for connection to an air pressure regulator 50.

It is envisioned that the cleaning solution 39 and the second cleaning solution 41 are different, but it is foreseen that they are identical. The cleaning solution 39 may be best for hard deposits and when sprayed creates soft depositions, therefore a different cleaner that is effective on wet and soft deposits would be more effective. In the preferred embodiment, cleaning solutions 39, 41 are a mix of cleaning solutions that allow for specific tasks, i.e. cleaning solution 39 is directed towards hard deposits and cleaning solution 41 is directed towards soft wet deposits, and the combination of the two alternating creates an effective clean.

The face plate 11 is sloped and includes a regulator knob 50, an air pressure gauge 52, a control panel 54, and a sensor port 56. The regulator knob 50 controls the air pressure in the cleaning system 1. The air pressure gauge 52 is a visual interpretation of the air pressure measured in pounds per square inch (psi), standard atmospheres (atm), or Pascals (pa). It is foreseen that the air pressure gauge 52 may be digital. The sensor port 56 attaches a sensor 60 to the cleaning system 1. The sensor 60 may, for example, be a vacuum air sensor that senses the air in the air intake, and if the pressure decreases due to a stall in the engine, this information will be sent to the cleaning system 1. It is foreseen that the sensor 60 may alternately be a vibration sensor, a power sensor, a temperature sensor, sound sensor, or any such sensor or combination of sensors known or later developed that will relay information to the cleaning system 1 that the engine has stalled during cleaning. It is foreseen that the sensor port 56 may also be a switch that must be on to receive signals from the sensor.

The bottom surface includes standing pegs 58, 59 to enable the cleaning system 1 the ability to position itself upright. The pegs 58, 59 are located in front of the wheels 30.

Referring now to FIG. 1A, the control panel 54 offers several options to the user. One function or button 70 runs cleaning solutions 39, 41 in a continuous spray. On the upper portions are indicators 71, 73, which indicate which cleaning solution 39, 41 is currently being sprayed or on, the system has stopped, and/or the vehicle has stalled. It is foreseen that indicators may be audio or visual (lights). A second function or button 72 runs the cleaning system 1 in a pulsed fashion that pulses the cleaning solutions 39, 41 installed in the canisters. It is envisioned that that if two cleaning solutions 39, 41 are being utilized, then in one configuration the first cleaning solution 39 and second cleaning solution 41 can be alternated equally. In another configuration, the first cleaning solution 39 is spray at a predetermined multiple (i.e twice, three times, etc) of the frequency of the second cleaning solution 41 or vice versa. In another configuration the first cleaning solution 39 is sprayed for a predetermined amount of time (i.e. thirty seconds, twenty seconds, etc) followed by a predetermined amount of delay (i.e. thirty seconds, twenty seconds, etc). This can be followed up with the second cleaning solution 41 being sprayed for a predetermined amount of time (i.e. thirty seconds, twenty seconds, etc) and then returning to the first cleaning solution 39 being sprayed for a predetermined amount of time.

The control panel 54 includes a service alert 74, a purge button 76, a hydrosafe protection mode button 78, and a start/stop service button 80. The service alert 74 goes on whenever the cleaning system is opened, and the cleaning system 1 may not operate with the service alert 74 activated. A purge button 76 exhausts all the cleaning solutions currently within the canisters 42, 44. The hydrosafe protection mode button 78 activates the sensor 60 and shuts down the cleaning system 1 if a stall is detected, as will be further described below. The start button 80 initializes the cleaning system 1 to begin spraying the cleaning solution 39, 41 as directed by the choice of spray pattern of the user. It is foreseen that each button or function may have a light and/or an audible sound associated with the activation or deactivation of the button.

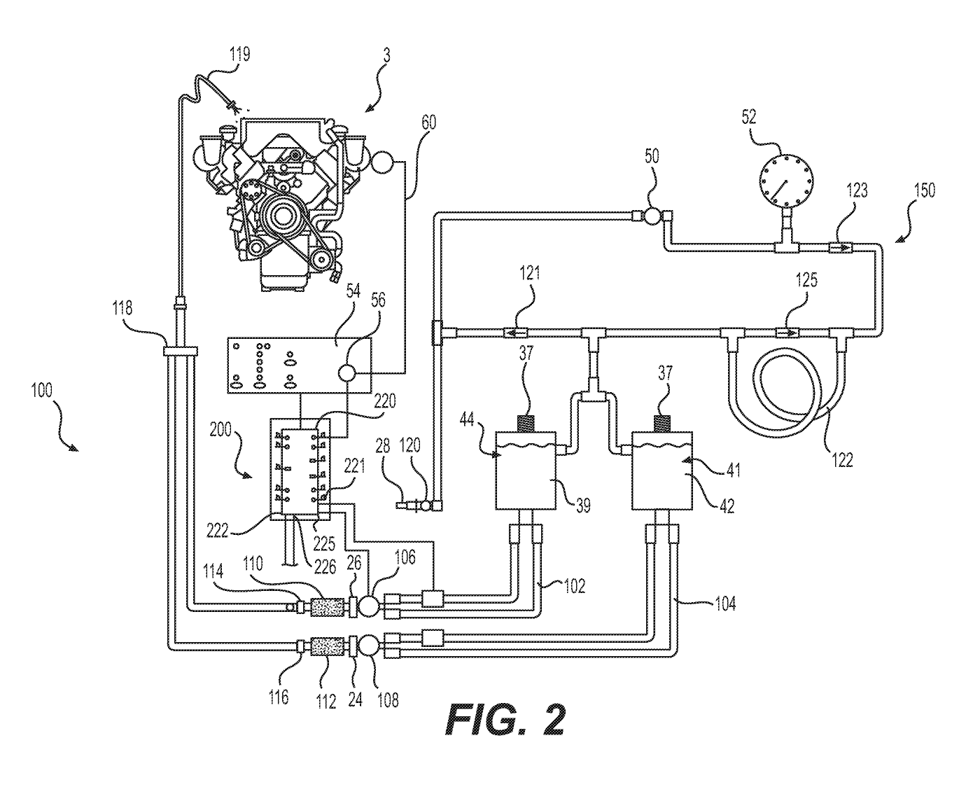

Referring now to FIG. 2, the canister assembly 100 cooperates with the housing 2 and the housing components as discussed above and is situated within the housing 2, as seen in FIG. 1. The canister assembly 100 includes hoses 102, 104, valves 106, 108, air pressure subassembly 150, a sensor control subassembly 200, filters 110, 112, solenoids 114, 116, and a nozzle 118, and nozzle engine adapter 119.

The air pressure subassembly 150 pressurizes outside air to be utilized by the pressurized canisters 42, 44. Outside air is circulated through the air port 28 by means of an outside air source (not shown) to a three way valve 120, then to the regulator 50, the air pressure gauge 52, and the pressurized air canisters 42, 44, and is then looped back all by means of air hosing and one way valves 121, 123, 125. A hose coil 122 is located between the air pressure gauge 52 and the pressurized canisters 42, 44, when in use in combination with valve 125 cooperate to capture moisture exhausted or back flowed from the pressurized canisters 42, 44.

The canister assembly 100 cooperates with the air pressure subassembly 150 to pressurize the canisters 42, 44 filled with cleaning solutions 39, 41 to ready the cleaning solutions 39, 41 to be output from the canisters 42, 44. Chemical resistant hosing 102, 104 is attached to the canisters 42, 44 as a release for the cleaning solutions 39, 41. The cleaning solutions 39, 41 flow to the valves 106, 108, which are controlled by a sensor control subassembly 200, as will be explained further below. When the valves are open, the cleaning solutions 39, 41 pass through a respective filter 110, 112 and a respective solenoid 114, 116 which directs the flow of the cleaning solutions 39, 41 outward and in a single direction. It is foreseen that the filters 110, 112 are connected to the first and second cleaning solution ports 24, 26 outside of the housing 2, so as to be easily replaced. The solenoids 114, 116 are connected to the first cleaning solution port 24 and the second cleaning solution port 26, respectively, and from there are connected via a hose to a three way nozzle 118. The three way nozzle 118 is connected to an engine adapter 119 on one end and the first cleaning solution port 24 and the second cleaning solution port 26 on the opposed end by means of a hose of sufficient length, such that the adapter 119 can easily affix or connect to one of: an air intake hose which may be located in front of a throttle body, a vacuum hose port, or a sensor port, which is dependent upon the make and model of the engine 3 or vehicle. The engine adapters 119 are optimized for quick connection to the preferred induction location for engines. It is foreseen that a second nozzle (not shown) may be placed on a different portion of the engine not used by the first nozzle 118, i.e. sensor port or vacuum port.

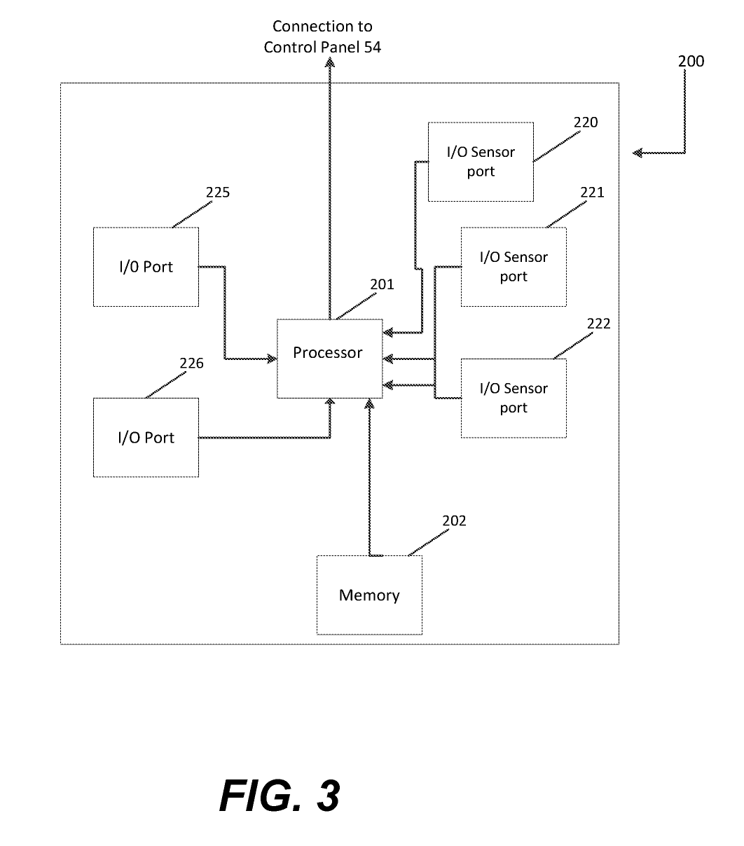

Referring now to FIG. 3, the sensor control subassembly 200 includes a processor 201, first, second, and third I/O sensor ports 220, 221, 222, a first and second I/O port 225, 226, and memory 202. The sensor control subassembly 200 is electronically connected to control panel 54. Examples of the processor 201 include, but are not limited to, a general purpose processor 201 configured for use in the cleaning system 1, a controller, an application-specific integrated circuit (ASIC), an FPGA (Field Programmable Gate Array), a RISC (Reduced Instruction Set Controller) processor, or an integrated circuit. The processor can be a single core or a multiple core processor. In one embodiment, the processor 201 is specifically suited for processing demands of stall information from sensor 60 at the first sensor port 220. The processor can be disposed on silicon or any other suitable material. In operation, the processor can receive and execute instructions and data stored in the memory (not shown). The memory 202 can be a RAM (Random Access Memory), a flash memory, a non-persistent memory device, or other devices capable of storing program instructions being executed.

The second and third sensor ports 221, 222 are electronically connected to sensors 106, 108, and the sensors 106, 108 detect and relay information about whether or not cleaning solution 39, 41 is flowing or has stopped. It is envisioned any sensor that can detect movement could accomplish this task, such as, but not limited to optical or fluid sensors. It is foreseen that the sensors 106,108 could also be level sensors that detect the amount of cleaning solution 39, 41 is left in the canisters 42, 44. It is foreseen that the level sensors could indicate no cleaning solution 39, 41 is remaining in the canister and would remove that cleaning solution from the spraying sequence.

The controller controls valves 106, 108, and computer firmware or software run the valves 106, 108 as determined by the selection from the user on the cleaning system 1 from the control panel 54. As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules, such as a phone or tablet application. The computer software products can also be component software, for example Java Beans (from Sun Microsystems) or Enterprise Java Beans (EJB from Sun Microsystems). Much functionality described herein can be implemented using computer software, computer hardware, computer firmware, or a combination.

As an example, if a thirty-to-thirty ratio is selected, then the valves 106, 108 are alternated in a frequency to allow the cleaning solutions 39, 41 to individually spray out for thirty seconds followed by a thirty second delay of non-spraying. As such, cleaning solution 39 would spray out for thirty seconds followed by a thirty second delay, then cleaning solution 41 would spray out for thirty seconds followed by a thirty second delay, and repeat. This cleaning process allows for the use of multiple cleaners delivered with a delay function to maintain a thermal shock conditions longer and to help with clearing of any pooled cleaners in the intake.

As another example, if a one-to-one ratio is selected, then the valves 106, 108 are alternated in a frequency to allow the cleaning solutions 39, 41 to spray out in a cyclical manner. For another example, if a three-to-one ratio is selected, then valve 106 opens three times as much as valve 108 to distribute the cleaning solutions 39, 41.

The cleaning process also allows for the use of cleaners that could not previously be used; the system's ability to limit the spray interval may prevent damaging the engine as would occur in the prior art. And by allowing an alternating or a cyclical pattern of spraying of the cleaning solutions 39, 41, the engine is repeatedly thermally shocked so as to cause fractures in the heavy deposits—even those that may be developed by the cleaning process itself. The thermocyclic pattern allows for the cleaning solutions to be more effective throughout the cleaning process rather than just the initial thermal shock. The cyclical pattern of spraying may remove pools of cleaner before they become an issue, as the cyclical spray pattern allows the vacuum of the air induction system to pass the cleaner through without pooling.

The sensor 60 is connected to the sensor port 56, which is electronically connected to the sensor control subassembly 200. If the processor receives information that the engine reaches a threshold minimum performance (e.g., is about to stall), then programming gives the engine a predetermined pause during service to allow the vehicle to clear itself and re establish a strong idle. If the processor receives information that the engine has stalled, then the controller can close both valves 106, 108 to stop the spraying completely in order to avoid hydrolock; this stopping may be called a hydrosafe function, as explained above.

It is foreseen that an application will take make, model, engine, and make year information to assist and advise in selecting the correct engine adapter 119 for the advised location for manual installation of the nozzle engine adapter 119.

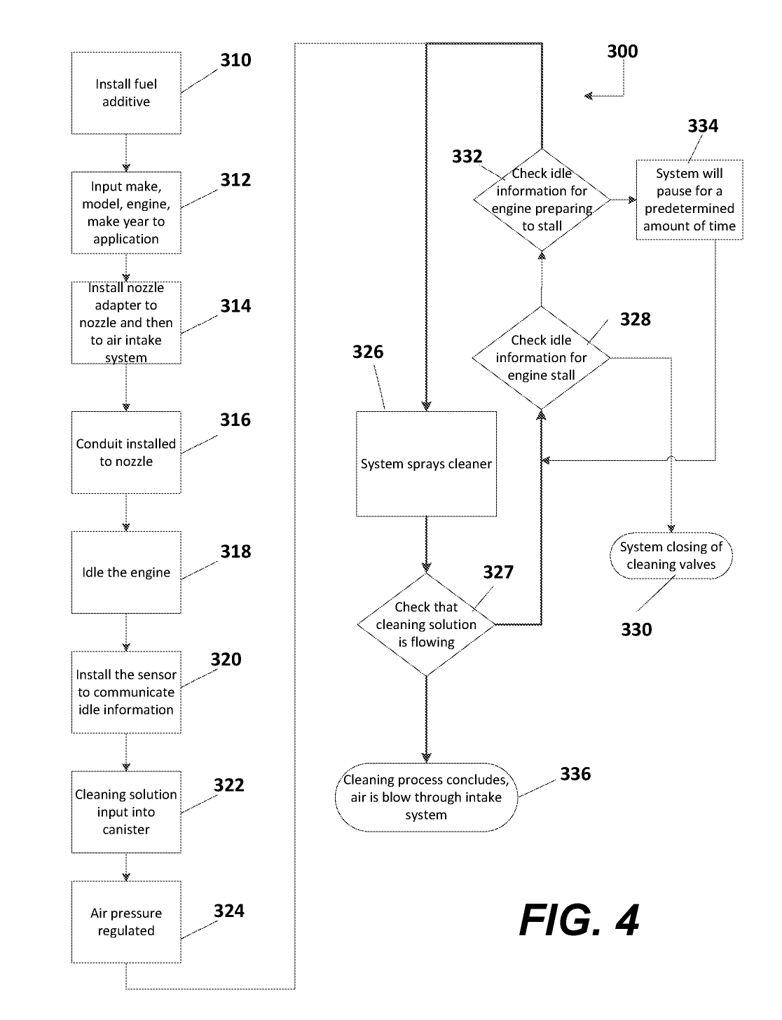

FIG. 4 is a flow diagram illustrating a method 300 for advanced gasoline engine air induction cleaning. At step 310, a fuel additive is installed into the gasoline tank via the filler neck.

At step 312, the make, model, engine, and make year, are input to an application to advise in selecting the correct engine adapter 119. At step 314, the engine adapter 119 is installed on the spray nozzle 118 and installed in the air intake system. This is envisioned to be one of: an air intake hose in front of a throttle body, a vacuum hose port, or a sensor port. It is foreseen that the method could include a step, wherein after step 312, the system will make a recommendation for the programming of the cleaning solutions that is best for that engine model (i.e what frequency of cleaners, what delay, what spray timer, what cleaners to use, etc). It is foreseen that these recommendations may be made from aggregate cleaning information that is received from the input of users and the programming (i.e. cleaning solution, spray timer, frequency, delay, etc) that was selected by those users and the models of the engines being cleaned. Cleaning information could be stored in a server, the cleaning information would include the programming selected and if and when the system had to delay cleaning due to a stop in service due to the engine about to stall or stalling. As an example, the programming selected wherein an adjustment had to be made would not be recommended in the future for that engine type.

At step 316, the cleaning solution hoses are installed on the nozzle 118.

At step 318, the vehicle is turned on and the revolutions per minute (rpm) are regulated to be between 1,800 and 2,500 rpms. It is foreseen this may be accomplished by either a scan tool or by supplying pressure to the throttle. Letting the vehicle run an idle at the rage of 2000 and 2500 rpms allows the vehicle engine to reach a steady operating temperature, and be more resistant to stall conditions.

At step 319, a minimum threshold point in engine information is determined and set in the system.

At step 320, a sensor 60 is installed that supplies information about the engine and whether or not it is slowing down, about to stall, or has stalled.

At step 322, cleaning solutions 39, 41, are input into the advanced gasoline air induction system canisters 42, 44. It is foreseen that for best results, the cleaning solutions 39, 41, should be different.

At step 324, the air is regulated from 1 psi to 100 psi dependent upon how much cleaner volume flow is desired.

At step 326, the advanced cleaning system 1 is set to spray or alternate thermo cycle spraying the cleaning solutions 39, 41, into the air intake system with or without a delay function. It is foreseen that the power cord is connected to one of a wall outlet, a jump pack, internal vehicle 12V outlet, or the vehicles battery. It is foreseen that different vehicles differ slightly at what speed and frequency the individual engine can handle the spraying of the cleaning solutions. It is foreseen that if the idle reduces to the point of a stall, the spray pressure may be adjusted down and the spray nozzle or the nozzle location on the intake may need to be changed.

At step 327, sensors 106, 108 detect and relay information about whether or not cleaning solution 39, 41 is flowing or has stopped. It is common for the fine nozzle orifices, or the cleaner hose filters to clog and to block the flow of the cleaners. It is foreseen that if a flow timer has been selected, then the sensor will monitor the fluid movement and indicate if the liquid is not flowing with the timing of the program selected (i.e for the total thirty seconds). If the cleaning solutions 39, 41 have both stopped or if only a single cleaning solution 39, 41 is being used, or if the single cleaning solution 39, 41, has stopped flowing through the conduit or hose a service interruption sounder may be initiated and the valves will close. If service is not completed, then a clogged filter or nozzle may be replaced, the user can restart the service by pressing the Start Service button on the keypad.

At step 336, when the sensors detect fluid not present in both cleaner lines, the nozzle 118 will then spray air for a predetermined programmed period of time to empty the internal and external cleaners hoses of liquid, then close the valves and may initiate a sounder indicating service complete. It is foreseen that the system will spray air for at least two minutes through the hoses and engine, and will then power off. It is foreseen that an alarm or sound sensor indicating attention is needed. It is foreseen that an alarm can trigger once the time for a complete total service is indicated.

If the cleaning solution(s) 39, 41 are still flowing, then at step 328, the hydrolock function and sensor 60 are constantly checking to see if the engine has stalled. The sensor being any sensor that can detect the engine has stalled, i.e. vacuum, air, temperature, power, rpm, vehicle computer, etc. If the engine has stalled, then at step 330, the system will shut down and operating will stop until the system is manually reactivated. This is done to avoid a hydrolock scenario that potentially harms the engine.

If engine stall is not detected at step 328, then at step 332 the hydrolock function and sensor 60 are constantly checking to see if the engine is about to stall (e.g., through monitoring the rpms of the engine). If the engine is about to stall or the engine idle is undesirably decreasing, the system pauses (step 334) for a predetermined amount of time to allow the engine to get back up to a predetermined rpm range or specific rpm for idle. The method 200 returns from step 334 to step 328 to check to see if the engine has stalled even after pausing. From these checks, if the engine has not stalled (step 328) or slowed (step 332), then the system will keep spraying and alternating the spray of the cleaning solutions 39, 41.

Referring now to FIG. 4, in another embodiment the nozzle 118 cooperates with a nozzle subassembly 400. The nozzle subassembly 400 includes an external excess cleaning solution collection bottle 410, nozzle adapter 412, adjustable air vents 414, engine adapter aperture 416, and a heat resistant bottom 418. The nozzle 118 connects with the external excess cleaning solution collection bottle 410 through the nozzle adapter 412. The nozzle adapter 412 may be a screw-in type mechanism, o-ring, or pressure lock, et cetera. The external excess cleaning solution collection bottle 410 is connected to the selected connection point on the engine through the adapter 119 or a delivery hose to the engine adapter aperture 416. The external excess cleaning solution collection bottle 410 provides a chamber outside of the engine to allow any excess cleaner to fall into it. The purpose of the external excess cleaning solution collection bottle 410 is to prevent excess cleaning from entering the intake and pooling within the engine. Excess liquid is created when the amount of liquid cleaner being delivered into the engine's air intake system is higher than the air intake system's ability to bring it to the intake valves and combustion chamber. The external excess cleaning solution collection bottle 410 provides an external space for the disparity between the amount of cleaning solution being delivered through an outlet 421, and the amount of cleaning that can be “breathed” or “burped” into the air intake system, to fallout in an area that is easy to clean out and safe to the engine, as another method to prevent hydrolock conditions.

In the illustrated embodiment, the nozzle adapter 412 aligns along an axis A with the outlet 421. It is foreseen that the nozzle adapter 412 and nozzle 118 may not align along axis A with outlet 421.

If it is found that the engine is breathing in too much, there are adjustable air vents 414 to reduce the amount of cleaning solution breathed in. The adjustable air vents have a handle 415 that allows a shade 417 that ranges from fully blocked to fully open with several iterations in between. It is envisioned the nozzle subassembly 400 works in conjunction with the hydrolock feedback sensor of the advanced gasoline air induction system 1, but may also work without such a feedback system.

The heat resistant bottom 418 maintains the coolness of the cleaning solutions 39, 41, so that they still create a thermal shock when they are breathed into the air intake system.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims. The specific configurations and contours set forth in the accompanying drawings are illustrative and not limiting.

1. An engine air intake cleaning system, comprising:
an enclosure for housing a cleaning agent;
a nozzle;
a conduit allowing movement of the cleaning agent from the enclosure to the nozzle;
a valve having first and second positions, the valve first position being an open position allowing the cleaning agent to pass therethrough, the valve second position being a closed position restricting the cleaning agent from passing therethrough;
a controller in communication with the valve to control the position of the valve; and
a sensor detecting engine idle information and communicating at least some of the detected engine idle information to the controller;
wherein the controller positions the valve at the second position when the controller determines from the communicated engine idle information that engine idle has reached a threshold minimum performance.

2. The engine air intake cleaning system of claim 1, further comprising:
a second enclosure for housing a second cleaning agent; and
a second valve having first and second positions, the second valve first position being an open position allowing the second cleaning agent to pass therethrough, the second valve second position being a closed position restricting the second cleaning agent from passing therethrough;
wherein the controller is in communication with the second valve to control the position of the second valve; and
wherein the controller positions the valve and second valve such that the flow of the cleaning agent and the second cleaning agent is alternated.

3. The engine air intake cleaning system of claim 2, wherein the controller alternates the valve between the valve first position and the valve second position at a frequency that is a predetermined multiple faster than a second frequency at which the controller alternates the second valve between the second valve first position and the second valve second position.

4. The engine air intake cleaning system of claim 1, wherein the controller maintains the valve at the second position for a predetermined amount of time after the controller determines from the communicated engine idle information that engine idle has reached the threshold minimum performance, thereby impeding the engine from stalling.

5. The engine air intake cleaning system of claim 1, wherein the controller maintains the valve at the second position after the controller determines from the communicated engine idle information that engine idle has reached zero performance, thereby preventing the engine from creating a hydro lock condition.

6. The engine air intake cleaning system of claim 1, wherein the sensor is one of: a vacuum sensor, an air pressure sensor, a power sensor, a temperature sensor, a vibration sensor, a rpm sensor, and sensor monitoring a vehicle computer.

7. The engine air intake cleaning system of claim 1, further comprising a nozzle adapter, allowing connection of the nozzle to at least one of the following engine outlets: an air intake hose, a vacuum hose port, or a sensor port.

8. An engine air intake cleaning system, comprising:
first and second enclosures for respectively housing first and second cleaning agents;
a nozzle;
conduit coupling the first and second enclosures to the nozzle for providing the first and second cleaning agents to the nozzle;
a first valve associated with the first cleaning agent;
a second valve associated with the second cleaning agent, the first and second valves each having an open position for allowing passage of the respective cleaning agent therethrough and a closed position restricting passage of the respective cleaning agent therethrough;
a controller to control the position of the first and second valves; and
a nozzle adapter configured for connection of the nozzle to an engine outlet;
wherein the controller positions the first and second valves to the open position in an alternating manner.

9. The engine air intake cleaning system of claim 8, further comprising a sensor detecting engine idle information and communicating at least some of the detected engine idle information to the controller; and wherein the controller positions the first and second valves at the second position when the controller determines from the communicated engine idle information that engine idle has reached a threshold minimum performance.

10. The engine air intake cleaning system of claim 9, wherein the controller maintains both the first and second valves at the closed position after the controller determines from the communicated engine idle information that engine idle has reached a zero performance, thereby preventing the engine from creating a hydro lock condition.

11. The engine air intake cleaning system of claim 9, wherein the controller maintains both the first and second valves at the closed position for a predetermined amount of time after the controller determines from the communicated engine idle information that engine idle has reached the threshold minimum performance, thereby impeding the engine from stalling.

12. The engine air intake cleaning system of claim 9, wherein the sensor is one of: a vacuum sensor, an air pressure sensor, a power sensor, a temperature sensor, a vibration sensor, a rpm sensor, and sensor monitoring a vehicle computer.

13. The engine air intake cleaning system of claim 8, wherein the controller alternates the first valve between the first valve first position and the first valve second position at a frequency that is a predetermined multiple faster than a second frequency at which the controller alternates the second valve between the second valve first position and the second valve second position.

14. An engine air intake cleaning system, comprising:
an enclosure for housing a cleaning agent;
a nozzle;
an excess cleaner collection container, the nozzle being situated within the collection container; and
a first hose allowing movement of the cleaning agent from the enclosure to the nozzle;
a second hose allowing fluid movement of the cleaning agent from the collection container to an opening in a vehicle engine, whereby the cleaning agent in the collection container is accessible to the engine.

15. The engine air intake cleaning system of claim 14, further comprising:
a valve having first and second positions, the valve first position being an open position allowing the cleaning agent to pass therethrough, the valve second position being a closed position restricting the cleaning agent from passing therethrough
a sensor that detects idle information from the engine and communicates at least some of the detected engine idle information to a controller; the controller in communication with the valve to control the position of the valve; and wherein the controller positions the valve at the second position when the controller determines from the communicated engine idle information that engine idle has reached a threshold minimum performance.

16. The engine air intake cleaning system of claim 15, wherein the controller maintains the valve at the second position for a predetermined amount of time after the controller determines from the communicated engine idle information that engine idle has reached the threshold minimum performance, thereby impeding the engine from stalling.

17. The engine air intake cleaning system of claim 15, wherein the sensor is one of: a vacuum sensor, an air pressure sensor, a power sensor, a temperature sensor, a vibration sensor, a rpm sensor, and sensor monitoring a vehicle computer.

18. The engine air intake cleaning system of claim 15, wherein the controller maintains the valve at the second position after the controller determines from the communicated engine idle information that engine idle has reached zero performance, thereby preventing the engine from creating a hydro lock condition.

19. An engine air intake cleaning system, comprising:
an enclosure for housing a cleaning agent;
a nozzle;
a nozzle adapter configured to connect the nozzle to an engine outlet;
a hose allowing movement of the cleaning agent from the enclosure to the nozzle;
a valve having open and closed positions;
a controller to control the position of the valve; and wherein
the controller alternates the position of the valve, thereby altering the flow of the at least one cleaning agent.

20. The engine air intake cleaning system of claim 19, wherein the valve open position allows the cleaning agent to pass therethrough and the valve closed position restricts the cleaning agent from passing therethrough; further comprising a sensor that detects idle information from the engine and communicates at least some of the detected engine idle information to the controller; and wherein the controller positions the valve at the closed position when the controller determines from the communicated engine idle information that engine idle has reached a threshold minimum performance.

21. The engine air intake cleaning system of claim 20, wherein the sensor is one of: a vacuum sensor, an air pressure sensor, a power sensor, a temperature sensor, a vibration sensor, a rpm sensor, and sensor monitoring a vehicle computer.

22. The engine air intake cleaning system of claim 19, wherein the controller maintains the valve at the closed position for a predetermined amount of time after the controller determines from the communicated engine idle information that engine idle has reached the threshold minimum performance, thereby impeding the engine from stalling.

23. The engine air intake cleaning system of claim 1, wherein the controller maintains the valve at the closed position after the controller determines from the communicated engine idle information that engine idle has reached zero performance, thereby preventing the engine from creating a hydro lock condition.

24. A method of cleaning the air induction of a vehicle engine, comprising the steps:
a. inputting a cleaning solution into a canister and pressurizing the canister;
b. installing at least one cleaning solution hose from the canister to a nozzle, such that the cleaning solution has a pathway from the canister to the nozzle;
c. installing a sensor on the vehicle engine;
d. idling the vehicle engine between predetermined revolutions per minute;
e. providing idle information from the sensor to a controller;
f. spraying the cleaning solution into the vehicle engine via the nozzle;
g. stopping the spray of the cleaning solution when the idle information received by the controller indicates at least one of: the vehicle engine is about to stall and the vehicle engine has stalled.

25. The method of claim 24, further comprising the step of inputting a second cleaning solution into a second canister and pressurizing the second canister; wherein:
the cleaning agent flows to a first valve and the second cleaning agent flows to a second valve;
the valves flow to the nozzle;
the first and second valves each have an open position for allowing passage of the respective cleaning agent therethrough and a closed position restricting passage of the respective cleaning agent therethrough;
the controller controls the position of the first and second valves; and
the controller positions the first and second valves to the open position in an alternating manner.

26. The method of claim 24, further comprising the step:
h. adding a fuel additive into the gasoline tank.

27. The method of claim 24, further comprising the steps:
h. inputting the make, model, engine, and make year to an application; and
i. obtaining engine nozzle adapter information from the application based on the input make, model, engine, and make year.

28. The method of claim 27, further comprising the step of:
h. gathering and storing stall information for when particular make, model, engine, and make year have stalled through the cleaning method;
i. using the stall information to make recommendations to user.

29. The method of claim 27, wherein the engine nozzle adapter is installed on one of:
an air intake hose in front of a throttle body, a vacuum hose port, or a sensor port.

30. The method of claim 24, further comprising the steps:
h. providing a sensor to determine at least one of: whether the cleaning agent canister is empty and whether cleaning agent has stopped flowing; and
i. blowing air from the nozzle to the vehicle engine once the determination of the sensor has been made.

31. An engine air intake cleaning system, comprising:
an enclosure for housing a cleaning agent;
a nozzle;
a conduit allowing movement of the cleaning agent from the enclosure to the nozzle;
a valve having first and second positions, the valve first position being an open position allowing the cleaning agent to pass therethrough, the valve second position being a closed position restricting the cleaning agent from passing therethrough;
a controller in communication with the valve to control the position of the valve; and
wherein the valve is in the first position for a predetermined amount of time and then moves to the second position for a predetermined amount of time.

32. The engine air intake cleaning system of claim 31, further comprising:
a second enclosure for housing a second cleaning agent; and
a second valve having first and second positions, the second valve first position being an open position allowing the second cleaning agent to pass therethrough, the second valve second position being a closed position restricting the second cleaning agent from passing therethrough;
wherein the controller is in communication with the second valve to control the position of the second valve; and
wherein the controller positions the valve and second valve such that:
a) the valve is in the first position for a predetermined amount of time while the second valve is in the second position; and
b) the valve is moved to the second position for a second predetermined amount of time, such that both valve and second valve are in the second position for the second predetermined amount of time, and after the second predetermined amount of time, the second valve is moved to the first position for a third predetermined amount of time while the valve is maintained in the first position.
